(19) United States
(12) Patent Application Publication
(10) Pub. No.: US 2012/0153205 A1
(43) Pub. Date: Jun. 21, 2012

(54) DEVICE FOR REGULATING THE FLOW OF MATERIALS INTO AN ENCLOSURE OR CONDUIT AND A SYSTEM AND APPARATUS INCLUDING SAID DEVICE

(75) Inventors: Carlos Leon Tomas, Sant Cugat Del Valles (ES); Javier Ragull Aviles, Terrassa (ES); Luis Carlos Carrillo Muñoz, Barbera Del Valles (ES); Maria Dolors Salvatierra Robert, Barbera Del Valles (ES); Jaime Bertral Gosch, Barbera Del Valles (ES); Angel Manuel Nuñez Bodelon, Cervello (ES)

(73) Assignee: AMBIENSYS, S.L., Barbera Del Valles (ES)

(21) Appl. No.: 13/377,627

(22) PCT Filed: Jun. 9, 2010
(86) PCT No.: PCT/ES2010/070388

§ 371 Date: Feb. 28, 2012

(30) Foreign Application Priority Data
Jun. 10, 2009 (ES) P 200901399

(51) Int. Cl. F16K 1/20; F16K 51/00; F16K 29/00

(52) U.S. Cl. 251/303; 137/315.01; 137/315.29

(57) ABSTRACT

The device of the invention for regulating the passage of adherent or tacky materials to an enclosure comprises:
a main hollow body with an access hole susceptible of being covered by a locking cover, and a lower opening;
a swinging locking cover, susceptible of adopting a closed position, covering the access hole, and an open position, being swung onto one of the inner walls of the main body;
cleaning means for the outer face of the cover, comprising a rotating cleaning disc shiftable between an inoperative position, allowing the passage of materials to the main body, and an operative cleaning position, the disc being juxtaposed to the outer face of the cover when the latter adopts the open position, removing by friction the material residues adhered to the face as the disc rotates.

### TECHNICAL FIELD OF THE INVENTION

The present invention relates to a device for regulating the passage of materials to an enclosure or conduit, particularly suitable for adherent or tacky materials, such as, for example, pasty materials used in the manufacture of paper, solid urban waste and assimilable industrial waste, etc.

The mentioned device for regulating the passage of materials is of the type comprising a main hollow body provided with an upper opening and a lower opening, the upper opening constituting an access hole susceptible of being covered by a locking cover; and a swinging locking cover, susceptible of adopting a closed position, covering the access hole, and an open position, the cover being swung onto one of the inner walls of the main body, an inner face being distinguished in the cover, said inner face oriented toward the inside of the main body when the cover adopts the closed position, and an outer face, opposite the previous one.

The invention is also comprised within the technical sector of systems for introducing and extracting materials, particularly solid urban waste or assimilable industrial waste, from inside a pressure tank or autoclave, as well as in the area of apparatuses for the treatment of said waste, provided with a pressure tank inside which the waste is subjected to pressure and temperature conditions that are greater than atmospheric conditions and is conveyed from an upper inlet opening to a lower outlet opening of the pressure tank.

### BACKGROUND OF THE INVENTION

Known devices used for regulating the passage of materials through a duct or the like, of the type comprising a pivoting cover, have certain drawbacks when the material circulating therethrough is tacky or tends to remain adhered both to the cover and to the walls of the main hollow body supporting the cover. This situation can lead, for example, to the cover to not correctly adopting its closure position, to a leak-tight closure not being thus formed and to not being able to assure the cut-off of the flow of material through the device.

In the treatment of solid urban waste or household waste and industrial waste, it is common to sterilize and partially dry said waste in order to transform its organic fraction into a homogenized byproduct, which facilitates its subsequent separation and recovery by means of circuits for recycling and/or utilization for energy purposes. The nature of this waste precisely brings about its tendency to remain adhered to the walls of the vessels containing it, so the means used to handle it must adjust to or be prepared so that this effect does not alter their working. This is the case of systems for introducing and extracting waste in a sanitation apparatus.

A known type of apparatus in which said sanitation treatment is carried out comprises a fixed vessel or pressure tank inside which there are arranged means for conveying the waste from an inlet end towards an outlet end. These vessels are provided at the inlet end with an upper opening and at the outlet end with a lower opening, provided with respective closure systems which allow sealing the vessel by means of pivoting covers, through which the waste to be treated is introduced and extracted once it is treated, respectively, generally by the effect of gravity.

When the pressure and the temperature inside the vessel reach the desired values, the pressure and temperature conditions are kept essentially constant therein while the waste is successively introduced by batches into the vessel and conveyed therein until it is extracted, also by batches and as it reaches the outlet end of the vessel, the sanitation of the waste per se being performed during its dwell time in the vessel, as described, for example, in patent document WO2008065002.

Each of the mentioned closure systems comprises a compression or decompression chamber for the waste provided with respective pivoting covers for opening and closing corresponding inlet and outlet openings of the chamber, one of which communicates with the inside of the vessel. When waste is introduced or extracted, the chambers temporarily house a batch of waste to be treated or treated waste, as the case may be, while it is compressed or decompressed, the covers being used to regulate introducing the waste in the chambers, for containing it and for subsequently extracting it. Until now, satisfactory solutions for solving the problem of the waste remaining adhered to the closure covers of the aforementioned chambers have been unknown.

Document JP03182258 discloses an apparatus for breaking down, disinfecting and sterilizing contaminated waste which connects a loading opening with a pressure seal mechanism. In the apparatus, an infectious organic and/or moist substance can be supplied on one hand to a chamber through a first cover that is open, or the organic substance can be directly supplied on the other hand to an autoclave through a lower chamber and a channel by means of another cover. Since a rotational mechanism is active, the chamber is positioned in the lower part of the mentioned covers, i.e., providing passage to the loading openings, to repeat the supply. The organic substance falls vertically into the autoclave and receives the action of a stirring mechanism. In such case, the infectious organic and/or moist substance or the water is stopped by a pressure seal device, to prevent it from being outwardly injected. The covers are closed while the material is sterilized in the autoclave and the pressure seal device is in pressure sealing conditions, so the system is disinfected and sterilized by vapor treatment. The residues that may have been deposited in the channel or in another part are removed by means of a ring provided with cleaning nozzles, through which a pressurized fluid is expelled.

Although in the previous case the use of cleaning nozzles for cleaning the channel or conduit has been provided, this solution is not always as effective when waste or materials of a different nature are being treated because some can present greater resistance to being entrained by the liquid coming out of the nozzles, especially if they are particularly adherent and/or tacky materials or waste.

Furthermore, the need to provide a solution for cleaning the closure covers that is compatible with maintaining the pressure and temperature conditions inside the vessel is clear.

Another objective is to provide a cleaning solution that can be adapted to the already existing treatment vessels and which therefore involves the least number of modifications, and alternatively, to get the apparatus for waste treatment to be simpler and/or to reduce the manufacturing costs compared with known apparatuses.

### DISCLOSURE OF THE INVENTION

For the purpose of providing a solution to the problems raised, a device for regulating the passage of materials to an enclosure or conduit, particularly suitable for adherent or tacky materials, is disclosed. The mentioned device comprises:

a main hollow body provided with an upper opening and with a lower opening, the upper opening constituting an access hole susceptible of being covered by a locking cover; and

a swinging locking cover, susceptible of adopting a closed position, covering the access hole, and an open position, the cover being swung onto one of the inner walls of the main body, an inner face being distinguished in the cover, said inner face oriented towards the inside of the main body when the cover adopts the closed position, and an outer face, opposite the previous one.

Essentially, the device according to the invention is characterized in that it furthermore comprises first cleaning means for the outer face of the cover, comprising a rotating cleaning disc shiftable between an inoperative position, in which it allows the passage of materials through the main body, and an operative cleaning position, in which the disc is juxtaposed to the outer face of the cover when the latter adopts the open position, such that it removes from the same by friction the material residues that may have adhered to it, as the disc rotates about its shaft.

According to another feature of the invention, the cleaning disc is provided with scraping members intended for removing the material residues adhered to the outer face of the cover when the mentioned cleaning disc adopts the operative cleaning position and rotates about its shaft.

The scraping members are preferably formed by one or more wedge-shaped bodies the bases of which are arranged on the face of the cleaning disc oriented towards the outer face of the cover, the wedges being located tangent to the contour of the mentioned face of the cleaning disc.

According to another feature of the invention, the scraping members are made of gunmetal. Particularly, the gunmetal typically contains between 10% and 8% tin, and the gunmetal of the scraping members is a Standard bronze according to the C-3220 UNE37103 standard.

According to another feature of the invention, the first cleaning means comprise an operating rod of the cleaning disc, attached to the rear face of the latter and coupled to the output shaft of a rotary motor through a magnetic coupling, all configured such that the rod is longitudinally shiftable between a first position, in which the cleaning disc adopts the inoperative position, and a second position, in which the cleaning disc adopts the operative position, and vice versa, and transmits a rotational movement to the cleaning disc as the rotary motor is operated.

According to another feature of the invention, the device for regulating the passage of materials to an enclosure or conduit comprises pivoting means arranged after the access hole by means of which the cover is hingedly attached to the inside of the main body, said pivoting means being made up of an arm the first end of which is hingedly attached to the main body and the second end of which is attached to the inner face of the cover, the cover being susceptible of pivoting about the first end of the arm in order to go from the open position to the closed position and vice versa, as the arm rotates about its hinged attachment with the main body.

According to another feature of the invention, the main body is provided in one of its inner walls and under the access hole with a housing suitable for housing the cover when the latter adopts the open position.

According to another feature, the device of the invention comprises second cleaning means for cleaning the material residues that can accumulate in the housing of the inner wall of the main body, the mentioned second cleaning means being made up of a rigid body arranged at the bottom of the housing and shiftable, by pushing means, from the bottom of the housing to the projection of the lower opening of the main body, entraining in its movement the material residues accumulated in the mentioned housing.

According to another feature of the invention, the device is provided with at least one retaining body, sinkable behind the inner surface of the wall of the main body, operable by corresponding operating means shifting it from an extended position, in which it projects from the inner surface of said wall to retain the cover in the closed position, to a sunken position, in which the mentioned retaining body is completely or partially concealed behind the inner surface of the wall of the main body, to release the cover from its closed position.

According to another aspect of the invention, a system for introducing and extracting materials, particularly solid urban waste or assimilable industrial waste, from inside a pressure tank or autoclave is disclosed. Said system is characterized in that it comprises at least two devices like the one of the invention described above arranged superimposed and connected to one another by means of a tubular element, the open upper end of the tubular element being coupled to the lower opening of the upper device, and the open lower end of the tubular element to the access hole of the lower device, the covers of the mentioned devices determining a leak-tight chamber inside which the housed materials can be pressurized or depressurized before being introduced in the tank or expelled to the exterior, respectively, by means of opening the locking cover of the lower device.

Finally, according to another aspect of the invention an apparatus for waste treatment, particularly for solid urban waste and assimilable industrial waste, is also disclosed, provided with a pressure tank inside which the waste is subjected to pressure and temperature conditions that are greater than atmospheric conditions, and is conveyed from an upper inlet opening to a lower outlet opening of the pressure tank. Essentially, the apparatus for waste treatment is characterized in that it is provided with two systems such as those described in the previous paragraph for introducing and extracting the waste to be treated and the treated waste, respectively, the lower opening of the lower device of the first system being connected to the upper inlet opening of the pressure tank and the upper opening of the upper device of the second system connected to the lower outlet opening of the pressure tank.

### BRIEF DESCRIPTION OF THE DRAWINGS

The attached drawings show by way of non-limiting example a preferred embodiment of the device for regulating the passage of materials to an enclosure or conduit, and of the system for introducing and extracting materials. In said drawings:

FIG. 1 is an elevational view of a pressure tank of the type provided in the apparatus for waste treatment object of the invention;

FIG. 2 is a perspective view of the device for regulating the passage of materials to an enclosure or conduit object of the invention;

FIGS. 3, 4 and 5 are sectional views of the device of FIG. 2 in successive steps for closing, opening and cleaning of the cover;

FIG. 6 is a longitudinally sectioned perspective view of the device shown in FIG. 3;

FIG. 7 is a perspective view of the system for introducing materials object of the invention comprising two devices such as the one in FIG. 2; and

FIG. 8 is a sectional view of the system shown in FIG. 7.

### DETAILED DESCRIPTION OF THE DRAWINGS

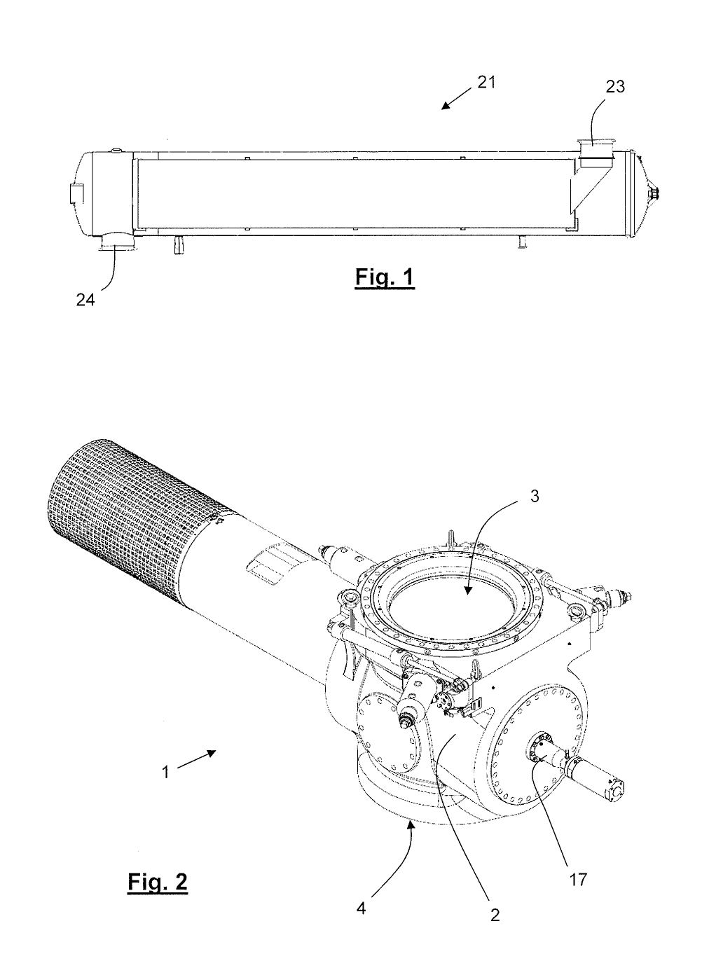

The apparatuses used for waste treatment, particularly for solid urban waste and assimilable solid waste, such as paperboards, office waste and industrial process byproducts such as slaughterhouse, vegetable plantation, composting plant waste, etc. are mainly provided with a pressure tank 21, such as the one depicted in FIG. 1. At the longitudinal ends of said pressure tank 21 respective upper inlet opening 23 for the waste to be treated and lower outlet opening 24 for the already treated waste are arranged and inside said tank 21 the waste is subjected for a predetermined time period to pressure and temperature conditions according to its composition. Means for conveying, shaking and/or stirring the waste introduced from the upper inlet opening 23 to the lower outlet opening 24 are arranged inside the pressure tank 21.

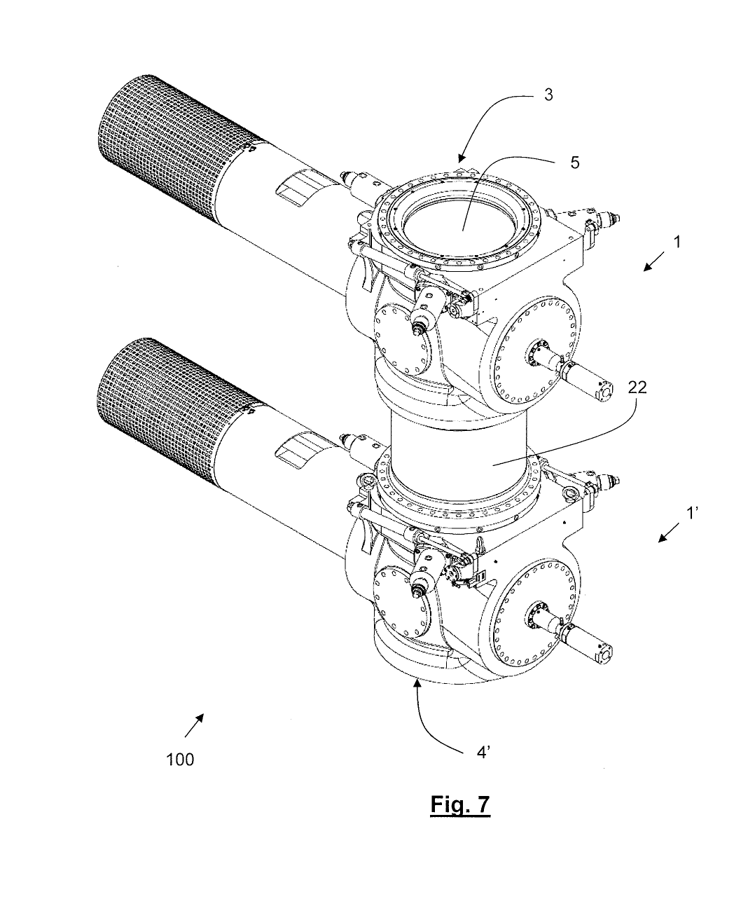

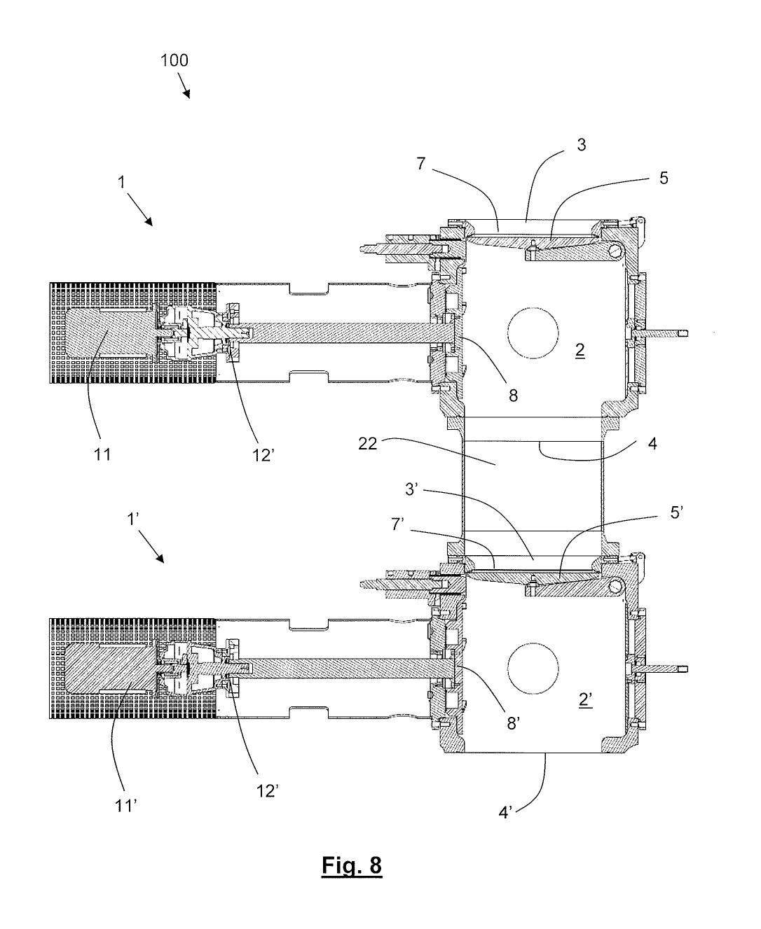

The apparatus for waste treatment object of the invention is provided with two systems 100 for introducing and extracting the waste to be treated and the treated waste, respectively. FIG. 7 shows the system 100 for introducing the waste to be treated, although it could also correspond to the system 100 for extracting the treated waste because they have the same design.

As can be seen in FIG. 7, the system 100 is in turn formed by two identical devices 1 and 1′, arranged superimposed and connected to one another by means of a tubular element 22. The device 1 is the one shown in FIGS. 2 to 6 and serves for regulating the passage of materials to an enclosure or conduit, said device 1 being particularly suitable for adherent or tacky materials, such as, for example, solid urban waste, assimilable industrial waste or materials forming paper pulp for manufacturing paper.

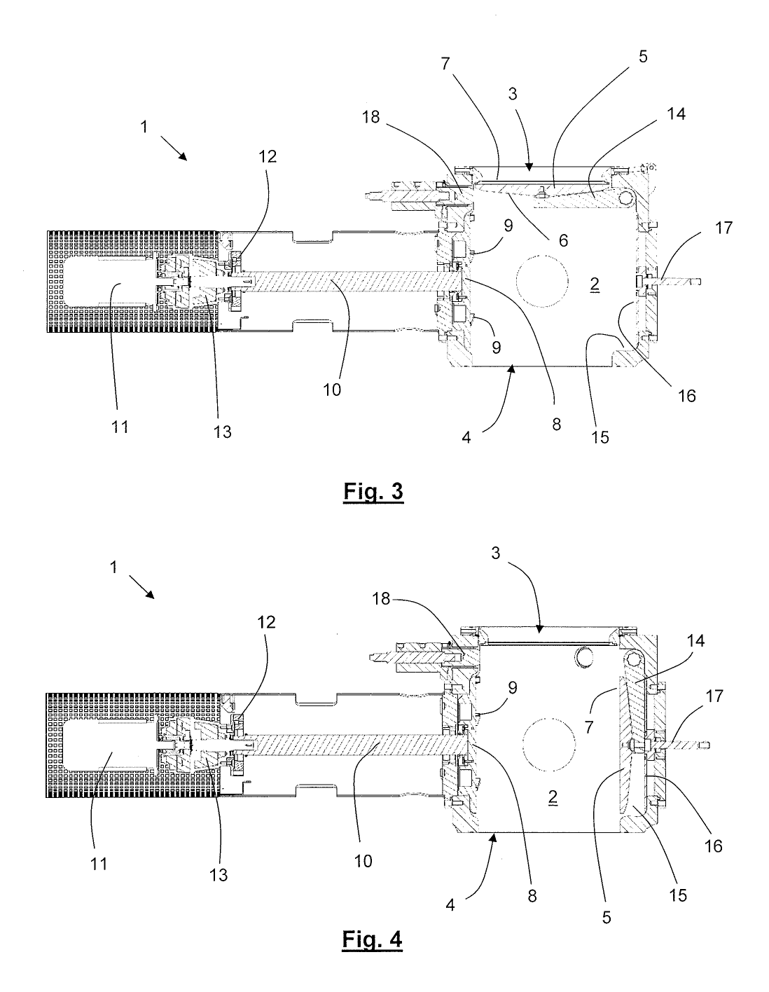

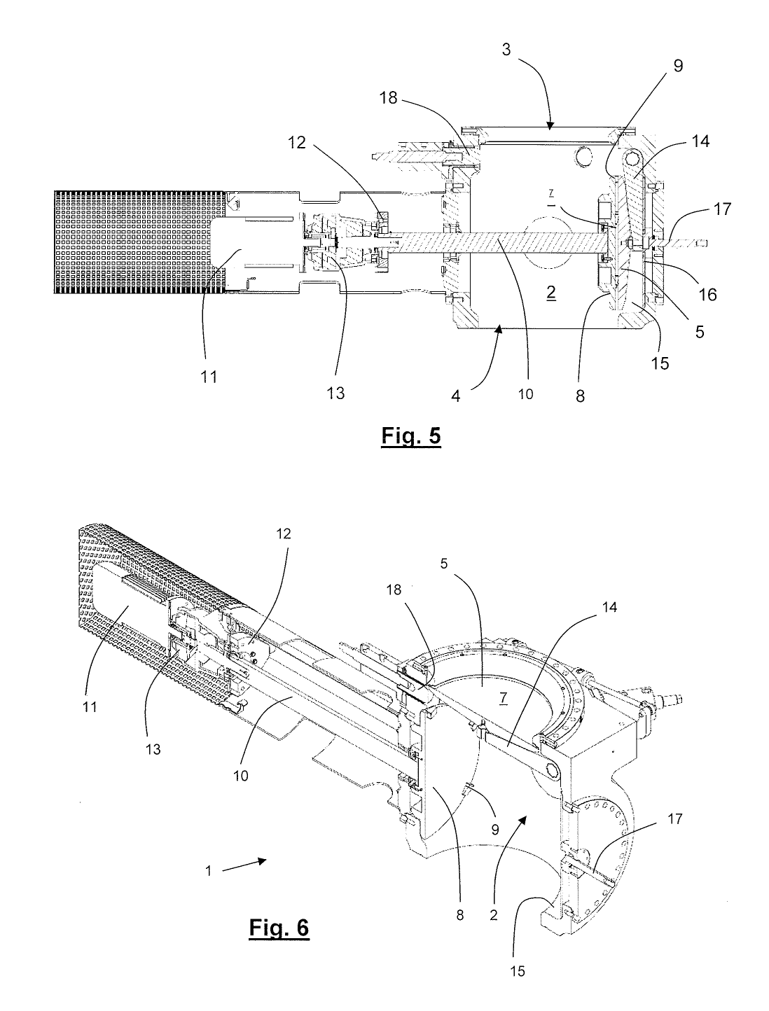

The device 1 comprises a hollow main body 2 provided with an upper opening or access hole 3 and with a lower opening 4. As can be observed in FIGS. 3 and 6, the access hole 3 is covered by a swinging locking cover 5. Said locking cover 5 can adopt a closed position (see FIG. 3), covering the access hole 3, and an open position (see FIGS. 4 and 5) in which the cover 5 is swung onto one of the inner walls of the main body 2. Hereinafter, the inner face 6 of the cover 5 will be the face that is oriented towards the inside of the main body 2 when the cover 5 is in the closed position, and the outer face 7 of the cover 5 will be the opposite face.

As is shown in FIGS. 3 to 6, the device 1 comprises pivoting means arranged after the access hole 3 by means of which the cover 5 is hingedly attached to the inside of the main body 2. The pivoting means are formed by an arm 14 the first end of which is hingedly attached to the main body 2 and the second end of which is attached by means of a ball joint to the center of the inner face 6 of the cover 5. When the arm 14 rotates about its hinged attachment with the main body 2, the cover 5 can pivot about the first end of the arm 14 in order to go from the open position to the closed position and vice versa.

The device 1 is also provided with at least one retaining body 18, sinkable behind the inner surface of the wall of the main body 2 (see FIGS. 3 to 6), which is activated by means of corresponding operating means (not depicted) shifting it from an extended position to a sunken position. In the extended position the retaining body 18 projects from the inner surface of the mentioned wall to retain the cover 5 in the closed position, whereas in the sunken position the retaining body 18 is completely or partially concealed behind the inner surface of the wall of the main body 2 to release the cover 5 from its closed position.

In FIGS. 3 to 6, it can be seen that the device 1 comprises first cleaning means for the outer face 7 of the cover 5, formed by a rotating cleaning disc 8 shiftable between an inoperative position and an operative cleaning position, depicted in FIGS. 4 and 5, respectively. The cleaning disc 8 is provided with scraping members 9 which remove the material residues that may have adhered to the outer face 7 of the cover 5 when the cleaning disc 8 is in the operative cleaning position as it rotates about its shaft.

It can be seen in detail in FIG. 6 that scraping members 9 are formed by several wedge-shaped bodies. Said wedges are located tangent to the contour of the face of the cleaning disc 8 which is oriented towards the outer face 7 of the cover 5 when the latter is in the open position (FIGS. 4 and 5). The scraping members 9 are made of standard bronze according to the C-3220 UNE37103 standard, particularly of the type known as gunmetal, which generally contains between 10% and 8% tin. As the cleaning disc 8 rotates about its shaft in the axial direction of the rod 10 (see FIGS. 3 to 6), the scraping members 9 remove the dirt accumulated on the outer face 7 of the cover 5 when it is juxtaposed to the latter (see FIG. 5).

In order for the cleaning disc 8 to be able to shift from the rest or inoperative position (see FIGS. 3 and 4), in which it allows the passage of materials through the main body 2, until accessing the outer face 7 of the cover 5 when the latter is in the open position, swung onto one of the inner walls of the main body 2, the rear face of the cleaning disc 8 is coupled to an operating rod 10 in turn coupled to the output shaft of a rotary motor 11 through a magnetic coupling 12. The rotary motor 11 comprises a frequency shifter 13 for being able to vary the rotational speed of the cleaning disc 8 according to the amount of waste and the nature thereof that may have accumulated on the outer face 7 of the cover 5.

In relation to the main body 2, in FIGS. 3 to 6 show that said main body 2 is provided on one of its inner walls and under the access hole 3 with a housing 15 suitable for housing the cover 5 when the latter adopts the open position. Residues of the materials to be treated can also accumulate in this housing 15 so second cleaning means made up of a rigid body 16 arranged at the bottom of the housing 15 and shiftable have also been provided in the device 1. The rigid body 16, with fine thickness, is shiftable from the bottom of the housing 15 to the projection of the lower opening 4 of the main body 2 by pushing means 17, such that when said pushing means 17 are activated, the rigid body entrains in its movement the residues accumulated in said housing 15.

As mentioned at the beginning, FIGS. 7 and 8 depict a system 100 for introducing materials, particularly solid urban waste or assimilable industrial waste, through the upper inlet 23, inside a pressure tank 21 such as the one of FIG. 1 and it can be seen that said system 100 is formed by two devices 1 and 1′ such as those described above. The two devices 1 and 1′ are superimposed and connected to one another by means of a tubular element 22. The open upper end of the tubular element 22 is connected to the lower opening 4 of the upper device 1, whereas the open lower end of the tubular element 22 is connected to the access hole 3′ of the lower device 1′. The space between the covers 5 and 5′ of the mentioned devices 1 and 1′ thus determines a leak-tight chamber inside which the housed materials can be pressurized or depressurized before being introduced in the tank 21 by means of opening the closure cover 5′ of the lower device 1′.

For introducing the materials or waste inside the pressure tank 21, the first cover 5 adopts the open position while the second cover 5′ remains in the closed position. Once the waste is loaded, the first cover 5 is closed, the waste to be treated being confined in the leak-tight chamber determined by the space between said covers 5 and 5′. It must be taken into account that the leak-tight chamber must be pressurized in order to reach the same pressure and temperature conditions as inside the pressure tank 21, for the purpose of allowing continuous working of the apparatus for waste treatment, minimizing energy losses.

Once the leak-tight chamber is pressurized, the cover 5′ will adopt the open position, allowing the waste or materials to be treated to pass into the pressure tank 21 where they will be conveyed and treated from the upper inlet 23 to the lower outlet 24.

In turn, a system 100 for extracting the already treated waste is arranged in the apparatus for waste treatment, particularly at the lower outlet 24 of the pressure tank 21. In this case, the leak-tight chamber determined by both covers 5 and 5′ must be pressurized before the lower cover 5′ goes to the open position for discharging the already treated waste outside the apparatus. Thus, in the first phase for the exit of the already treated waste, the cover 5 will be in the open position and the cover 5′ in the closed position, such that the already treated waste accumulates on the cover 5′. Since the cover 5 is in the open position, the treated waste that is gradually accumulated will be under the same pressure and temperature conditions as inside the pressure tank 21. In a second phase, the cover 5 will be closed and the treated waste will be confined in the leak-tight chamber determined by the space between both covers 5 and 5′. Said chamber will be depressurized during said confinement until equalizing the conditions with the conditions outside the treatment apparatus. Once depressurized, the cover 5′ will be opened and the waste will be discharged to the exterior.

1. A device for regulating the passage of materials to an enclosure or conduit, especially suitable for adherent or tacky materials, comprising:
a hollow main body provided with an upper opening and with a lower opening, the upper opening constituting an access hole susceptible of being covered by a locking cover;
a swinging locking cover, susceptible of adopting a closed position, covering the access hole, and an open position, the cover being swung onto one of the inner walls of the main body, an inner face being distinguished in the cover, said inner face oriented towards the inside of the main body when the cover adopts the closed position, and an outer face, opposite the previous one;
the device further comprises first cleaning means for the outer face of the cover, comprising a rotating cleaning disc shiftable between an inoperative position, in which it allows the passage of materials through the main body, and an operative cleaning position, in which the disc is juxtaposed to the outer face of the cover when the latter adopts the open position, such that it removes from the same by friction the material residues that may have adhered to it as the disc rotates about its shaft.

2. The device according to claim 1, characterized in that the cleaning disc is provided with scraping members, intended for removing the material residues adhered to the outer face of the cover when the mentioned cleaning disc adopts the operative cleaning position and rotates about its shaft.

3. The device according to claim 1, characterized in that the scraping members are formed by one or more wedge-shaped bodies the bases of which are arranged on the face of the cleaning disc oriented towards the outer face of the cover, the wedges being located tangent to the contour of the mentioned face of the cleaning disc.

4. The device according to claim 2, characterized in that the scraping members are made of gunmetal.

5. The device according to claim 1, characterized in that the first cleaning means comprise an operating rod of the cleaning disc, attached to the rear face of the latter and coupled to the output shaft of a rotary motor through a magnetic coupling, all configured such that the rod is longitudinally shiftable between a first position, in which the cleaning disc adopts the inoperative position, and a second position, in which the cleaning disc adopts the operative position, and vice versa, and transmits a rotational movement to the cleaning disc as the rotary motor is operated.

6. The device according to claim 1, characterized in that it comprises pivoting means arranged after the access hole by means of which the cover is hingedly attached to the inside of the main body, said pivoting means being made up of an arm the first end of which is hingedly attached to the main body and the second end of which is attached to the inner face of the cover, the cover being susceptible of pivoting about the first end of the arm in order to go from the open position to the closed position and vice versa, as the arm rotates about its hinged attachment with the main body.

7. The device according to claim 1, characterized in that the main body is provided in one of its inner walls and under the access hole with a housing suitable for housing the cover when the latter adopts the open position.

8. The device according to claim 7, characterized in that it comprises second cleaning means for cleaning the material residues that can accumulate in the housing of the inner wall of the main body, the mentioned second cleaning means being made up of a rigid body arranged at the bottom of the housing and shiftable, by pushing means, from the bottom of the housing to the projection of the lower opening of the main body, entraining in its movement the material residues accumulated in the mentioned housing.

9. The device according to claim 1, characterized in that is provided with at least one retaining body, sinkable behind the inner surface of the wall of the main body, operable by corresponding operating means shifting it from an extended position, in which it projects from the inner surface of said wall to retain the cover in the closed position, to a sunken position, in which the mentioned retaining body is completely or partially concealed behind the inner surface of the wall of the main body, to release the cover from its closed position.

10. A system for introducing and extracting materials, particularly solid urban waste or assimilable industrial waste, from inside a pressure tank or autoclave, characterized in that it comprises at least two devices according to claim 1 arranged superimposed and connected to one another by means of a tubular element, the open upper end of the tubular element being coupled to the lower opening of the upper device, and the open lower end of the tubular element to the access hole of the lower device, the covers of the mentioned devices determining a leak-tight chamber inside which the housed materials can be pressurized or depressurized before being introduced in the tank or expelled to the exterior, respectively, by means of opening the locking cover of the lower device.

11. An apparatus for waste treatment, particularly for solid urban waste and assimilable industrial waste, provided with a pressure tank inside which the waste is subjected to pressure and temperature conditions that are greater than atmospheric conditions, and is conveyed from an upper inlet opening to a lower outlet opening of the pressure tank, characterized in that it is provided with two systems according to claim 10 for introducing and extracting the waste to be treated and the treated waste, respectively, the lower opening of the lower device of the first system being connected to the upper inlet opening of the pressure tank and the upper opening of the upper device of the second system connected to the lower outlet opening of the pressure tank.
